(19) United States
(12) Patent Application Publication
(10) Pub. No.: US 2004/0239331 A1
(43) Pub. Date: Dec. 2, 2004

(54) Dual capacitive-coupled sensor for hybrid ignition coil

(76) Inventor: Kenneth McQueeney, Los Gatos, CA (US)

Correspondence Address: MCDERMOTT WILL & EMERY LLP, 600 13TH STREET, N.W., WASHINGTON, DC, 20005-3096, US

(21) Appl. No.: 10/804,230

(22) Filed: Mar. 19, 2004

Related U.S. Application Data
(60) Provisional application No. 60/456,223, filed on Mar. 21, 2003.

(51) Int. Cl. F02P 17/00

(52) U.S. Cl. 324/402

(57) ABSTRACT

A diagnostic system for analyzing the operation of an engine is provided including a capacitive probe for simultaneously detecting an amplitude of a first and a second electric near field present proximate a hybrid or DIS ignition coil housing. The capacitive probe includes a fastening device configured to removably attach the capacitive probe to the ignition coil housing and a body bearing a first signal detector and a second signal detector. Each of the first signal detector and a second signal detector are arranged adjacent a location of a respective one of the first and second electric near fields for detecting an amplitude of the respective electric near field. Each signal detector outputs a signal representative of a respective electric near field.

### CROSS REFERENCE TO RELATED APPLICATIONS

This application claims priority from and is related to U.S. Provisional Application No. 60/456,223, filed Mar. 21, 2003, entitled “DUAL CAPACITIVE-COUPLED SENSOR FOR HYBRID IGNITION”, by inventor Kenneth A. McQueeney, (Attorney Docket No. 66396-029). The contents of the provisional application are hereby incorporated by reference in its entirety.

### BACKGROUND

1. Field

This patent application is directed to the field of ignition coils. It is more specifically directed to a dual capacitive-coupled sensor for hybrid ignition coils and more particularly to such probe configured for placement in electric near fields proximate a hybrid ignition coil as a means of sensing the signals that are delivered to spark plugs by the coil.

2. Description of Related Art

Ignition coils are commonly used in internal combustion engines to boost a low voltage supply voltage to the very high voltage level that is necessary to initiate and sustain a spark across a spark plug gap of a spark plug. The spark ignites a fuel-air mixture in an associated engine cylinder, causing increased pressure in the cylinder which produces movement of a piston within the cylinder. Historically, a single ignition coil was used in combination with a distributor to supply the high voltage needed by the spark plugs. The distributor was connected between the ignition coil and the spark plugs to sequentially distribute, using a rotor, the high voltage generated by the ignition coil to each of the spark plugs.

The ignition coil itself is, essentially, a transformer having a very large turn ratio, typically between 1:50 to 1:100, between the primary and secondary, which transforms the low voltage in a primary winding provided by the sudden opening of the primary current to a high voltage in a secondary winding. In older ignition systems, the ignition coil is connected to the center or coil terminal of a distributor cap by an insulated wire. High voltage from the ignition coil is distributed from the coil terminal to side or spark plug terminals of the distributor cap by means of a rotor. As the tip of the rotor spins in the cap past a series of contacts (one contact per cylinder), a high-voltage pulse from the coil arcs across the small gap between the rotor and the contact and continues down the spark-plug wire to the spark plug on the appropriate cylinder, thus distributing the spark to each spark plug terminal at a predetermined timing.

More recently, ignition systems have evolved to “distributorless” ignition systems having one coil per cylinder (e.g., conventional coil-on-plug (COP)) or one coil per cylinder pair (e.g., a direct ignition system (DIS) or Hybrid). Distributorless ignition systems, as the name implies, do not utilize distributor caps or rotors and, instead, incorporate an ignition coil over each plug (or plug pair) or an ignition coil near each plug (coil near plug or CNP)(or plug pair). The ignition coil generates the high voltage and supplies it only to the single spark plug (e.g., COP) or spark plug pair (e.g., DIS or Hybrid) with which it is associated. Coil-on-plug (COP) ignitions generally comprise a spark coil integrally mounted on spark plug, which protrudes into and is mounted in an engine cylinder and terminates in spark gap. The spark coil conducts transformed, high voltage direct current to the spark plug using internal connections. The coil receives low voltage direct current via a wiring harness that has a distal end coupled to a primary coil of the coil and a proximal end coupled to a battery.

Some distributorless ignition systems (e.g., hybrid) are configured so that at least one of the two plugs in the pair is buried or otherwise inaccessible (e.g., one or both plugs are COP), whereas other distributorless ignition systems (e.g., DIS) are configured so that both plugs in the pair are accessible. For example, in the hybrid ignition system, the ignition coil may be connected to one spark plug by a conventional ignition wire and to the other companion spark plug by means of a direct connection (e.g., a COP connection, such as a rigid extension or bus protruding from the bottom of the ignition coil to the spark plug). Thus configured, the DIS and hybrid ignitions simultaneously generate and output two different high voltage signals and associated electric near fields. As is commonly known, it is with these electric near fields that an appropriately configured sensor, such as but not limited to that shown in U.S. Pat. No. 6,396,277, the content of which is incorporated herein by reference, may be used to develop waveforms of the ignition cycle to aid in detection of and diagnosis of ignition system anomalies.

A single signal detector is often used to detect the signals on each spark plug. The process usually begins with a technician clipping or placing the signal detector adjacent the housing of a first ignition coil. When the engine is operated, the ignition coil generates an electric near field each time the spark plug is fired. The voltage of this electric near field is typically proportional to the voltage that the ignition coil delivers to the spark plug. The signal detector detects this electromagnetic field and the detected signal may be processed to extract the most relevant information and the results reported to the technician. The signal detector is then clipped or placed adjacent a subsequent ignition coil and the process repeated.

However, since the hybrid coil generates and outputs two different high voltage signals, two separate near electric fields are correspondingly present. When analyzing the operation of the combustion engine cylinders associated with the hybrid ignition coil, it is necessary to separately detect both fields that are being present proximate the hybrid ignition coil. Prior art signal detectors are not capable of simultaneously detecting the two separate fields from a single hybrid ignition coil.

### SUMMARY

This disclosure relates to a dual capacitive-coupled sensor for hybrid ignition coils, as well as a detection process and diagnostic system for detecting near electric fields present proximate hybrid ignition coils.

In one aspect, a capacitive probe is provided for simultaneously detecting a plurality of electric near fields present proximate a hybrid or DIS ignition coil. The capacitive probe includes a base portion, a fastening device by which the base portion of the capacitive probe may be removably attached to an ignition coil housing of an ignition coil under test, and a positioning member adapted to move along at least one axis relative to the base portion. The capacitive probe also includes an arm connecting the positioning member to at least one of the base portion and the fastening device and a plurality of capacitive sensors arranged on the positioning member, each capacitive sensor having an electrical lead connected thereto, wherein at least one of the positioning member and arm are adapted to move along or about at least one axis relative to the base portion.

A diagnostic system for analyzing the operation of an engine is provided including a probe for simultaneously detecting an amplitude of a first and a second electric near field present proximate a hybrid or DIS ignition coil housing. The probe includes a fastening device configured to removably attach the probe to the ignition coil housing and a body bearing a first signal detector and a second signal detector. Each of the first signal detector and a second signal detector are arranged adjacent a location of a respective one of the first and second electric near fields for detecting an amplitude of the respective electric near field. Each signal detector outputs a signal representative of a respective electric near field.

A method for simultaneously detecting a plurality of electric near fields present proximate a hybrid or DIS ignition coil housing comprising the steps of providing a capacitive probe comprising a fastening device configured to removably attach the capacitive probe to the ignition coil housing and a body, the body bearing a first signal detector and a second signal detector; attaching the capacitive probe to the ignition coil housing; positioning the first signal detector proximate a position of the ignition coil housing adjacent a location of a first electric near field; positioning the second signal detector proximate a position of the ignition coil housing adjacent a location of a second electric near field; simultaneously detecting the first electric near field using the first signal detector and detecting the second electric near field using the second signal detector, and outputting from each of the first signal detector and second signal detector a signal representative of a respective one of the first and second electric near field.

Other aspects and advantages of the present disclosure will become apparent to those skilled in this art from the following description of preferred aspects taken in conjunction with the accompanying drawings. As will be realized, the disclosed concepts are capable of other and different embodiments, and its details are capable of modifications in various obvious respects, all without departing from the spirit thereof. Accordingly, the drawings, disclosed aspects, and description are to be regarded as illustrative in nature, and not as restrictive.

### BRIEF DESCRIPTION OF THE DRAWINGS

FIG. 1 is a perspective view of a hybrid ignition coil to which the probe is attached for the purpose of detecting near electric fields present proximate the coil;

FIGS. 2A and 2B are perspective views of the probe;

FIGS. 2C and 2D are perspective views of the probe shown in FIGS. 2A and 2B attached to the hybrid ignition coil shown in FIG. 1;

FIGS. 3A and 3B are waveforms showing normal signals detected by the probe;

FIGS. 4 and 5 are waveforms showing abnormal signals detected by the probe; and

FIG. 6 illustrates a diagnostic system for detecting and reporting on the electromagnetic fields that are present proximate the hybrid ignition coil.

The figures referred to herein are examples provided and drawn for clarity of illustration and are not intended to be limiting in any way. The figures are not necessarily drawn to scale and are not necessarily inclusive of every feature or aspect of the objects or concepts featured therein. Elements having the same reference numerals refer to elements having similar structure and function.

### DETAILED DESCRIPTION

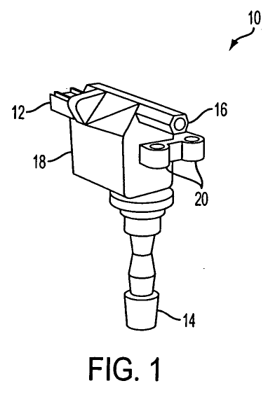

FIG. 1 is a perspective view of a hybrid ignition coil 10 such as the Model No. F-722 available from Diamond Electric Mfg. Corp., of Dundee, Mich. Generally, hybrid ignition coil 10 is used in a hybrid ignition system, which is a distributorless ignition system (“DIS”). In a hybrid ignition system, a single coil is used to fire two spark plugs. One plug is connected to the ignition coil in a coil-over-plug (“COP”) configuration, in which the plug is connected to the ignition coil via a rigid extension protruding from the housing of the ignition coil. The other plug may be conventionally mounted to the engine and connected to the hybrid ignition coil by an ignition wire. This plug is called the companion plug.

As shown in FIG. 1, hybrid ignition coil 10 may include an input connector 12 into which a low input voltage is delivered. This is typically 12 volts, although different voltages also may be used. Input connector 12 is sometimes configured to also receive a control signal, separate from the low input voltage. In these situations, an electronic switch (not shown) inside the hybrid ignition coil 10 acts to deliver the low input voltage to the ignition coil when so instructed by the control signal. In other situations, there is no control signal and the power signal is controlled externally and only delivered to the ignition coil when firing of the spark plugs connected to it is desired.

The hybrid ignition coil 10 may include a first output terminal 14 that is typically connected to a first spark plug (not shown) of a pair of plugs that serves as the COP-configured plug. The hybrid ignition coil 10 may also include a second output terminal 16 that is typically connected to the second, companion spark plug (not shown) of the pair through an ignition wire.

The hybrid ignition coil 10 may also include an ignition coil (not visible) housed in a housing 18. The ignition coil typically consists of a primary winding that is connected to the low voltage input 12 and a secondary winding that is electrically connected to the COP and companion plugs through electrical connectors attached to output terminals 14, 16, respectively. The number of turns in the secondary winding relative to the number of turns in the primary winding to select a desired voltage boost function of the ignition coil. Housing 18 can assume a broad variety of shapes and configurations and is typically secured to the engine by inserting an electrical connector attached to the first output terminal 14 into the spark plug cylinder and by tightening mechanical fasteners (e.g., bolts)(not shown) through a flange 20 into the engine.

In operation, the hybrid ignition coil 10, upon receiving the low input voltage at the primary winding, as described above, generates a positive-going high voltage signal and a negative-going high voltage signal. In the case of the hybrid ignition coil shown in FIG. 1, the negative-going high voltage signal is delivered to the COP plug via the electrical connector attached to the first output terminal 14 and the positive-going high voltage signal is delivered to the companion plug via an electrical connector attached to second output terminal 16.

As each of the positive and negative-going high voltage signals are generated, a corresponding electric near field is generated. One of the electric near fields is substantially proportional to the electric field supplying the negative-going voltage to the COP plug and the other electric near field is substantially proportional to the electric field supplying the positive-going voltage to the companion plug. By measuring these electric near fields, information about the operation of the ignition system may be gleaned. Alternatively, the probe (described below) may be used in connection with hybrid ignition coils that operate the COP spark plug with a positive-going voltage and the companion spark plug with a negative-going voltage. Thus, the particular polarity of the output voltage is not germane to the operation of the probe.

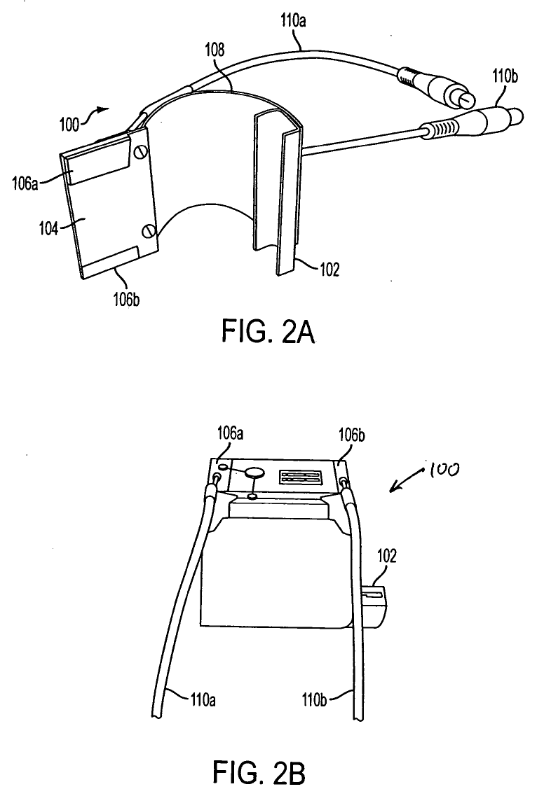

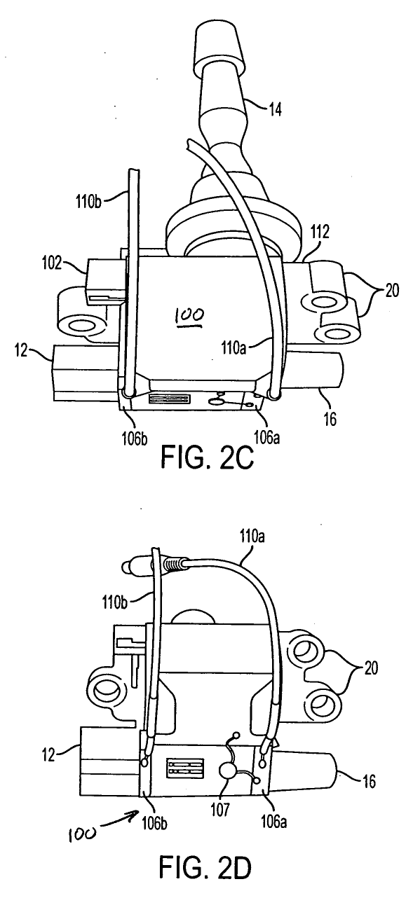

FIGS. 2A and 2B illustrate one example of a probe 100 that may be used to detect the electric near fields present proximate the hybrid ignition coil 10. FIGS. 2C and 2D illustrate the probe 100 mounted on the hybrid ignition coil 10. As shown in FIGS. 2A and 2B, probe 100 includes a U-shaped mounting clip 102 and a positioning member 104 on which capacitive signal detectors 106a and 106b are mounted. Capacitive signal detectors 106a and 106b each may be formed from a capacitive plate mounted to the positioning member 104.

To compensate for the differences in the magnitudes of the positive-going high voltage signal and the negative-going high voltage signal, capacitive signal detector 106a may be formed to be larger than capacitive signal detector 106b, as shown in FIG. 2A. Alternatively, or additionally, a capacitor 107 (see FIG. 2D) may be coupled to one or both of the signal detectors to equalize the detected signal. Positioning member 104 is connected to mounting clip 102 by an arm 108 that places the detection plate in the proper positioning for the particular hybrid ignition coil being tested. Mounting clip 102, positioning member 104 and arm 108 may be formed from any conventional non-magnetic metal, alloy, plastic, or polymer. Signal detectors 106a and 106b may comprise any conventional electrically-conductive material such as, but not limited to, copper.

Probe 100 further includes output cables 110a electrically connected to capacitive signal detector 106a and 110b electrically connected to capacitive signal detector 106b. As is described in detail below, output cables 110a and 110b are connected to analysis equipment, such as a dual trace scope, for generating a visual representation of the detected electric fields. Any conventional engine analyzer, lab scope, ignition scope, or display, such as but not limited to a Snap-On® MODIS® module, available from Snap-On® Diagnostics of San Jose, Calif., may be used in conjunction with probe 100. In between the physical sampling location of the two fields is an area in which both fields can appear on a single scope trace, albeit with tangled fields. Analysis of such a tangled waveform is difficult owing to the amount and form of the information presented. Therefore, it is preferred to provide the capacitive signal detector 106a, 106b outputs to a scope adapted for dual traces (e.g., the Snap-On® MODIS®).

As shown in FIGS. 2C and 2D, probe 100 is mounted to the hybrid ignition coil 10 by an interference fit between the U-shaped mounting clip 102 and a lip portion 112 formed on housing 18 of the hybrid ignition coil 10. Mounting clip 102 and arm 108 may be configured and sized such that proper alignment of clip 102 on lip 112 causes capacitive signal detectors 106a, 106b to be oriented within the electric near fields so as to permit detection thereof.

While the probe 100 shown in the figures is configured to be mounted to the hybrid ignition coil shown in FIG. 1, it will be understood that the clip 102 and arm 108 may be configured differently for mounting on coils having a different housing design than the coil of FIG. 1 such that an associated positioning member is optimally aligned to measure the desired electric near fields. In other words, the particular configuration of the clip 102 (or other mechanical attachment device) and arm 108 (or other placement or orienting device) is variable to a significant degree, so long as the capacitive signal detectors 106a, 106b are disposed within a respective electric near field so as to permit detection thereof. As but one additional example, arm 108 may comprise two separate arms that are independently positionable relative to each other along at least one axis to permit adjustment of a single probe to a plurality of varied coil 10 configurations. Clip 102 broadly comprises any conventional means for temporary attachment of objects (e.g., clip, stand, magnet, wires, resilient bands, friction, etc.).

As described above, one purpose of the signal detectors 106a and 106b may be to detect the fields that are present proximate the ignition coil, primarily by the secondary winding of the ignition coil. The capacitive signal detectors 106a, 106b output a signal corresponding to the sensed electric near field to analysis equipment (e.g., a lab scope) over output cables 110a and 110b, respectively. While the capacitive signal detectors 106a, 106b are shown as single-plate devices, the capacitive signal detectors may comprise devices of it will be understood that any configuration that is capable of detecting the field present proximate the ignition coil may be used for this purpose. Background on the use and structure of sensors for use within electric near fields may be found, for example, in the disclosure of the patent application titled “Universal Capacitive Adapter For Engine Diagnostics” filed on Feb. 6, 2004, by Snap-On Technologies Inc. on behalf of the inventor, Kenneth A. McQueeney (patent application No. Not Yet Assigned), which are each hereby incorporated by reference in their entirety.

In normal operation of the hybrid ignition coil 10 and the associated engine, the pair of spark plugs that are controlled by the hybrid ignition coil are operated in a reciprocal fashion. In other words, when the cylinder associated with the COP spark plug is in its compression stroke, the cylinder associated with the companion spark plug is in its exhaust stroke and when the cylinder associated with the COP spark plug is in its exhaust stroke, the cylinder associated with the companion spark plug is in its compression stroke.

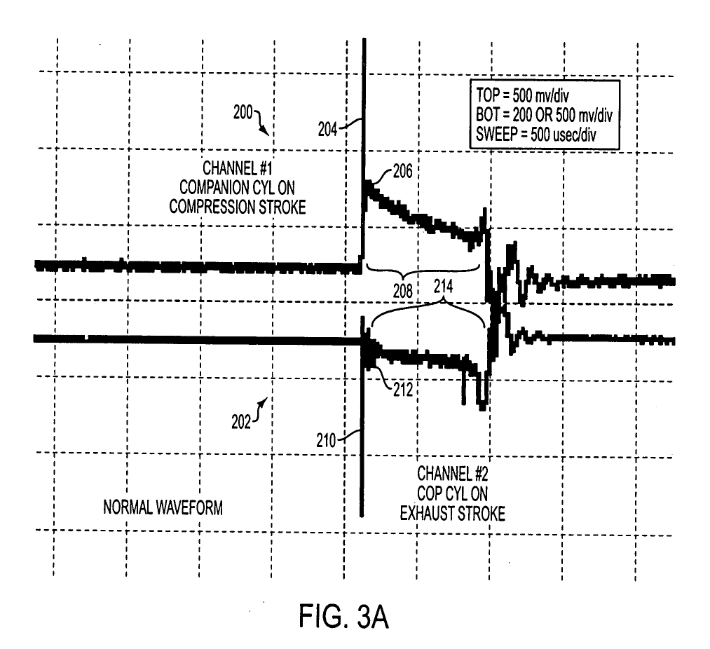

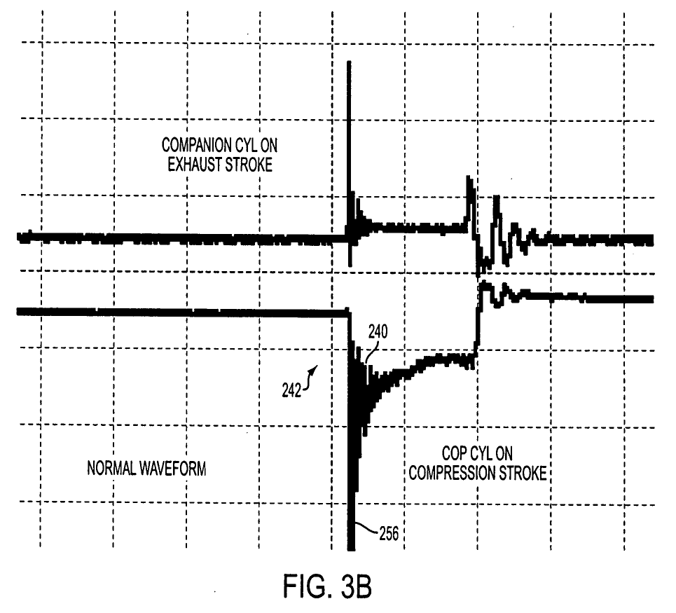

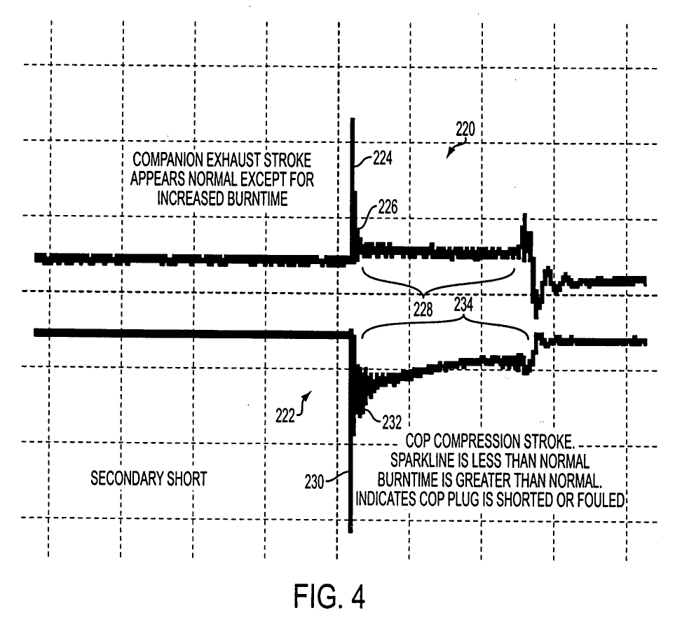

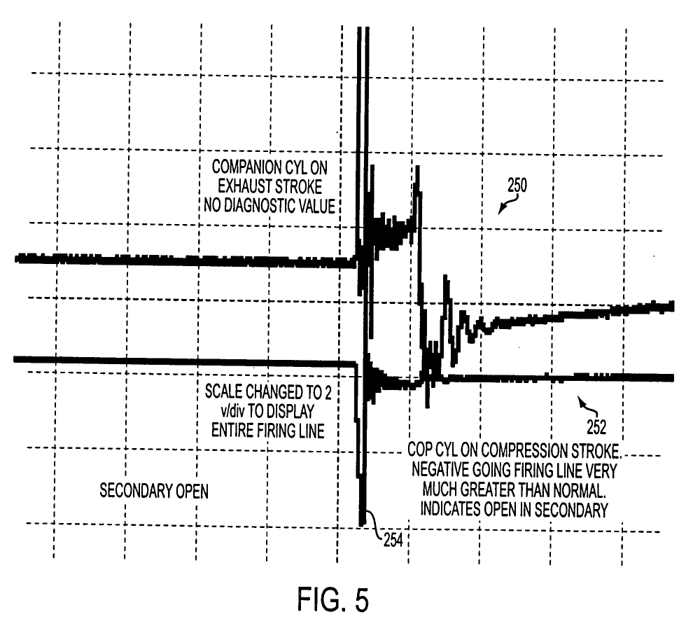

FIGS. 3A and 3B illustrate waveforms that show the detected electromagnetic fields associated with a COP spark plug and a companion spark plug during normal operation of an engine. FIGS. 4 and 5 illustrate waveforms that show the detected electromagnetic fields associated with a COP spark plug and a companion spark plug during abnormal operation of an engine. In FIGS. 3A and 3B, the upper waveform is that of the signal detected by capacitive signal detector 106a, which is the positive-going signal associated with the companion spark plug and the lower waveform is that of the signal detected by capacitive signal detector 106b, which is the negative-going signal associated with the COP spark plug.

In FIGS. 3A-5, the capacitive signal detectors 106a, 106b are connected to a dual trace scope, such as the Snap-On® MODIS® after connection of the probe 100 to the associated hybrid or DIS ignition coil. To facilitate alignment of the probe 100 relative to the ignition coil, alignment markings or other guides may be provided. The positive going and negative going waveforms will appear on alternate traces. In one aspect, it is preferred that the scope controls be set with a 500 mv/div top trace, a 200 or 500 mv/div bottom trace, and a 500 μsec/div sweep. The triggering is preferably set so that leading edge triggering takes place for both negative and positive signals.

The upper traces of FIGS. 3A-3B respectively show proper normal triggering for companion cylinder compression and exhaust strokes, whereas bottom traces of FIGS. 3A-3B respectively show proper normal triggering for COP cylinder exhaust and compression strokes. FIG. 3A shows a waveform 200 that represents the positive-going signal associated with the companion cylinder when the companion cylinder is on its compression stroke. Waveform 202 represents the negative-going signal associated with the COP cylinder when the COP cylinder is on its exhaust stroke. Shown in waveform 200 are the firing line 204, which is a short duration high voltage that initiates a breakdown across the spark plug gap, the spark line 206, which is the voltage appearing at the top of the spark plug during burn time, shown at 208, which is the length of time that an arc occurs across the spark plug gap. Similarly, waveform 202 shows firing line 210, spark line 212 and burn time 214 of the COP cylinder. The waveforms shown in FIGS. 3A and 3B are used in the diagnostic testing of an engine to determine whether an engine under test is operating properly by comparing the waveforms obtained during a test to these waveforms.

FIG. 4 shows a waveforms 220 and 222 which represent the signals detected from the probe when the companion cylinder is on its exhaust stroke and the COP cylinder is on its compression stroke, respectively. When compared to the waveforms shown in FIGS. 3A and 3B, which show normal operation of the COP and companion cylinders, it can be seen that the burn times 228, 234 are increased in both waveforms and that the spark line 232 for the COP cylinder is less than normal (as compared to FIGS. 3A, 3B).

If any ignition coil (e.g., COP) shows top and bottom traces with burntimes (e.g., spark duration or spark time)(i.e., the length of time that an arc occurs across the spark plug gap, the time being measured from a point immediately after the firing line and lasting until the coil energy becomes too low to continue the arc (typically about 1-5 ms)), about 30% greater than normal, then either the companion cylinder or COP cylinder plug/wiring is shorted or fouled. To determine which component is at fault, the traces must be analyzed to determine which sparkline (e.g., spark voltage or burn voltage)(i.e., the voltage appearing at the top of the spark plug during burntime, typically taken as the voltage at the start of burntime which is usually between about 2-4 KVp) is about ½ normal amplitude when on the compression stroke. If it is the top trace, as displayed in the figures, the problem is with the companion cylinder and if it is the bottom trace, the problem is with the COP cylinder. As shown in FIG. 4, a problem with the sparkline of the COP cylinder (i.e., low sparkline) is evident on the COP cylinder compression stroke.

FIG. 5 shows waveforms 250 and 252 which represent the signals detected from the probe 100 when the companion cylinder is on its exhaust stroke and the COP cylinder is on its compression stroke, respectively. When compared to the waveforms shown in FIG. 3B, which show normal operation of the COP and companion cylinders in their compression and exhaust strokes, respectively, it can be seen that the firing line 254 of waveform 252 (the COP cylinder) is much greater than the normal firing line 256. As shown in FIG. 5, the backswing of firing line 254 overlaps the other waveform trace 250, making distinction therebetween problematic. It is advantageous to use a scope with a multi-color display so as to enable clear distinction between the two traces, particularly in a region where the traces may overlap.

The scale of the waveform has been adjusted to 2V/div show the entire firing line on the display. A greater than normal firing line in the COP compression stroke waveform 252 indicates on open condition or near-open condition in the COP cylinder circuit. It is not necessary for the deviation of the measured firing line from the “normal” firing line to be a specific amount of deviation from the normal signal for the plug or wiring to be labeled as faulty. Any deviation from the normal signal may indicate that further investigation into the plug or wiring may be warranted. It is up to the operator of the system to determine if such further investigation is necessary given the particular purpose of the testing procedure. This applies to all of the parameters obtainable from the detected signal.

Although not shown in the figures, a detected companion waveform showing a greater than normal spark line would indicate an open condition in the companion cylinder circuit.

In accord with the above disclosure, a method for simultaneously detecting a plurality of electric near fields present proximate a hybrid or DIS ignition coil housing, can be understood to comprise the steps of providing a capacitive probe 100 comprising a fastening device 102 configured to removably attach the capacitive probe to the ignition coil housing 10 and a body, the body bearing a first signal detector 106a and a second signal detector 106b and attaching the capacitive probe to the ignition coil housing. Then the first signal detector is positioned proximate a position of the ignition coil housing adjacent a location of a first electric near field and the second signal detector is positioned proximate a position of the ignition coil housing adjacent a location of a second electric near field. The positioning may be ganged or separate in accord with a number of degrees of freedom of the body. In other words, each of the first signal detector 106a and a second signal detector 106b may be independently provided on arms capable of movement (translationally and/or rotationally) about one or more axes and thus may be positionable relative to each other and to the housing. Alternately, as shown, the first signal detector 106a and a second signal detector 106b may be arranged in a fixed position relative to each other. The method also includes simultaneously detecting the first electric near field using the first signal detector 106a and detecting the second electric near field using the second signal detector 106b and outputting from each of the first signal detector and second signal detector a signal representative of a respective one of the first and second electric near field.

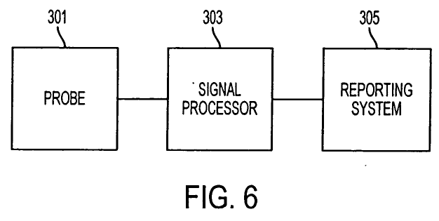

FIG. 6 illustrates a diagnostic system for detecting and reporting on the electric near fields that are present proximate the hybrid or DIS ignition coil. As shown in FIG. 6, a probe 301, such as one of the probes described above, may be optionally be connected to a signal processor 303 which, in turn, may optionally be connected to a reporting system 305. The signals or waveforms output from the probe 301, which are representative of the sensed electric near fields, may be processed, shaped, and/or amplified by a signal processor 303, which may comprise an amplifier, to extract or to emphasize any portion(s) of the output signals (e.g., the most common types of needed information, which could include burn time, firing line and spark line).

The raw signals or waveforms output from the probe 301, or the conditioned signals or waveforms, are preferably output to a reporting system 305. The reporting system 305 could include a trace scope that simply shows the waveform or signal emanating from the probe 301 or from the signal processor 303. Reporting system 305 could provide numerical values for some or all of the important parameters, or other visual or tonal representations thereof, such as burn time, firing line and spark line. Reporting system 305 comprises at least one of a display device, a printing device, communication device (e.g., output port, phone line, IR, RC, or wireless communication), and a electronic storage device (e.g., hard drive, CD-ROM, removable port memory device, etc.).

Reporting system 305 may comprise any conventional engine analyzer, lab scope, ignition scope, or display, such as but not limited to a Snap-On® MODIS® module, and may further comprise a computer and local area network. Although the probe is shown as being connected to the signal processor, and although the signal processor is shown as being connected to the reporting system, it should be understood that either or both of these connections could be wired connections or wireless connections.

Embodiments described herein or otherwise in accord with the concepts presented herein may include or be utilized with any appropriate voltage source, such as a battery, an alternator and the like, providing any appropriate voltage such as, but not limited to, about 9 Volts, about 12 Volts, about 14 Volts, about 42 Volts and the like.

The embodiments described herein may be used with any desired system or engine. Those systems or engines may comprise items utilizing fossil fuels, such as gasoline, natural gas, propane and the like; non-fossil fuels, such as hydrogen or ethanol; electricity, such as that generated by battery, magneto, solar cell and the like; wind and hybrids; or combinations of the above. Those systems or engines may be incorporated into other systems, such as an automobile, a truck, a boat or ship, a motorcycle, a generator, an airplane and the like.

I claim:

1. A capacitive probe for simultaneously detecting a plurality of electric near fields present proximate a hybrid or DIS ignition coil, the capacitive probe comprising:
a base portion;
a fastening device by which the base portion of the capacitive probe may be removably attached to an ignition coil housing of an ignition coil under test;
a positioning member adapted to move along at least one axis relative to the base portion,
an arm connecting the positioning member to at least one of the base portion and the fastening device; and
a plurality of capacitive sensors arranged on the positioning member, each capacitive sensor having an electrical lead connected thereto,
wherein at least one of the positioning member and arm are adapted to move along or about at least one axis relative to the base portion.

2. A capacitive probe for simultaneously detecting a plurality of electric near fields present proximate a hybrid or DIS ignition coil according to claim 1, wherein the plurality of capacitive sensors consists of a first capacitive sensor and a second capacitive sensor.

3. A capacitive probe for simultaneously detecting a plurality of electric near fields present proximate a hybrid or DIS ignition coil according to claim 2, wherein the first capacitive sensor and second capacitive sensor comprise metallizations having different areas.

4. A capacitive probe for simultaneously detecting a plurality of electric near fields present proximate a hybrid or DIS ignition coil according to claim 3, wherein an area of a first capacitive sensor associated with a positive going output of the ignition coil under test is larger than an area of a second capacitive sensor associated with a negative going output of the ignition coil under test.

5. A capacitive probe for simultaneously detecting a plurality of electric near fields present proximate a hybrid or DIS ignition coil according to claim 2, wherein at least one of the first capacitive sensor and second capacitive sensor comprises a metal plate.

6. A capacitive probe for simultaneously detecting a plurality of electric near fields present proximate a hybrid or DIS ignition coil according to claim 2, wherein at least one of the positioning member and arm are adapted to move along or about at least one axis relative to the base portion.

7. A capacitive probe for simultaneously detecting a plurality of electric near fields present proximate a hybrid or DIS ignition coil according to claim 6, wherein the arm comprises a curvilinear plate.

8. A capacitive probe for simultaneously detecting a plurality of electric near fields present proximate a hybrid or DIS ignition coil according to claim 2,
wherein the first capacitive sensor is associated with a positive going output of the ignition coil under test and the second capacitive sensor is associated with a negative going output of the ignition coil under test, and
wherein a capacitor is disposed to connect at least one of the first capacitive sensor and the second capacitive sensor to at least one of the positioning member and the an arm to substantially equalize an amplitude between the first capacitive sensor and the second capacitive sensor.

9. A diagnostic system for analyzing the operation of an engine, the diagnostic system comprising:
a capacitive probe for simultaneously detecting an amplitude of a first and a second electric near field present proximate a hybrid or DIS ignition coil housing, the capacitive probe comprising a fastening device configured to removably attach the capacitive probe to the ignition coil housing and a body, the body bearing a first signal detector and a second signal detector,
wherein each of the first signal detector and a second signal detector are arranged adjacent a location of a respective one of the first and second electric near fields for detecting an amplitude of the respective electric near field, and
wherein each signal detector outputs a signal representative of a respective electric near field.

10. A diagnostic system for analyzing the operation of an engine according to claim 9, the diagnostic system further comprising:
a signal processor for receiving the signals output from the capacitive probe and processing the signals.

11. A diagnostic system for analyzing the operation of an engine according to claim 10, the diagnostic system further comprising:
a reporting system for receiving signals processed by the processing system and generating a physical representation of the processed signals.

12. A method for simultaneously detecting a plurality of electric near fields present proximate a hybrid or DIS ignition coil housing, comprising the steps of:
providing a capacitive probe comprising a fastening device configured to removably attach the capacitive probe to the ignition coil housing and a body, the body bearing a first signal detector and a second signal detector;
attaching the capacitive probe to the ignition coil housing;
positioning the first signal detector proximate a position of the ignition coil housing adjacent a location of a first electric near field;
positioning the second signal detector proximate a position of the ignition coil housing adjacent a location of a second electric near field;
simultaneously detecting the first electric near field using the first signal detector and detecting the second electric near field using the second signal detector, and
outputting from each of the first signal detector and second signal detector a signal representative of a respective one of the first and second electric near field.

13. A method for simultaneously detecting a plurality of electric near fields present proximate a hybrid or DIS ignition coil housing according to claim 12, further comprising the step of:
processing a signal output by at least one of the first signal detector and second signal detector using at least one of a signal processor and amplifier.

14. A method for simultaneously detecting a plurality of electric near fields present proximate a hybrid or DIS ignition coil housing according to claim 12, further comprising the step of:
reporting at least one signal output by the first signal detector and second signal detector to at least one of a display device, a printing device, communication device, and a electronic storage device.
